(19) United States
(12) Patent Application Publication
(10) Pub. No.: US 2006/0081032 A1
(43) Pub. Date: Apr. 20, 2006

(54) Method for determining acidic gases and sensor

(76) Inventors: Thomas Brinz, Bissingen (DE); Vladimir Mirsky, Regensburg (DE); Otto S. Wolfbeis, Regensburg (DE); Jorg Jockel, Gerlingen (DE); Qingli Hao, Regensburg (DE)

Correspondence Address: KENYON & KENYON LLP, ONE BROADWAY, NEW YORK, NY, 10004, US

(21) Appl. No.: 11/240,229

(22) Filed: Sep. 29, 2005

(30) Foreign Application Priority Data
Sep. 30, 2004 (DE) 102004047466.4

(51) Int. Cl. G01N 27/12

(52) U.S. Cl. 73/23.31; 73/31.05; 422/90; 436/100

(57) ABSTRACT

A method and a sensor for determining acidic gases in gas mixtures, such as hydrogen chloride, sulfur dioxide, or nitrogen dioxide. A polymer layer whose electrical conductance changes under the effect of the gas to be determined is exposed to the gas mixture, and the electrical conductance, the electrical resistance, or the impedance of the polymer layer is determined. For the desorption of the gas to be determined, the polymer layer is heated at certain time intervals to a temperature above ambient temperature.

### BACKGROUND INFORMATION

It is known that in cable fires in particular large amounts of gaseous hydrogen chloride may be released, which cause health problems. Suitable sensors capable of reliably detecting even small amounts of released hydrogen chloride or other acidic combustion gases such as sulfur dioxide or nitrogen oxides and thus make early detection of fires possible are therefore needed.

Thus, for example, BR 9105139 describes a sensor for determining hydrogen chloride on the basis of a sensitive polyaniline layer. However, this system has an insufficient regeneration capability after being exposed to hydrogen chloride at room temperature so that this sensor is unable to be used as a fire detector.

An object of the present invention is to provide a method and a sensor for determining acidic gases which make it possible to accurately detect such gases without exhibiting the disadvantages of the sensors of the related art.

### SUMMARY OF THE INVENTION

The method according to the present invention and the sensor according to the present invention have the advantage that the object of the present invention is achieved in an advantageous manner. A sensitive layer is used, the electrical properties of which are to be modified markedly even upon contact with the smallest amounts of an acidic gas to be determined, the absorption of the gas to be determined being reversible. For the desorption of the gas to be determined, the sensitive layer is heated at certain time intervals to a temperature above the ambient temperature. Simple regeneration of the sensitive layer is thus ensured.

Thus, a polymer layer having basic functional groups, such as polyaniline, is suitable as a sensitive layer. This polymer has a high affinity for acidic gases, such as hydrogen chloride among others.

In a further advantageous embodiment of the present invention, the electrical conductance, i.e., the electrical resistance, or the impedance of the polymer layer is determined using two electrodes which are in contact with the polymer layer. A current flowing between the electrodes or a voltage applied between the electrodes is measured.

In a particularly advantageous embodiment of the present invention, the polymer layer is periodically heated preferably to an elevated temperature of 60° C. to 400° C., so that the gases that may have been absorbed are desorbed.

The sensor allows acidic gases in the ppb range to be determined without exhibiting significant cross-sensitivity to water vapor or carbon dioxide. It is furthermore characterized by a long-term stability for months.

### BRIEF DESCRIPTION OF THE DRAWINGS

FIG. 1 shows a schematic illustration of an exemplary embodiment of a sensor such as used in the method according to the present invention.

FIG. 2 shows the result of a measurement in which a sensor according to FIG. 1 was exposed to hydrogen chloride.

### DETAILED DESCRIPTION

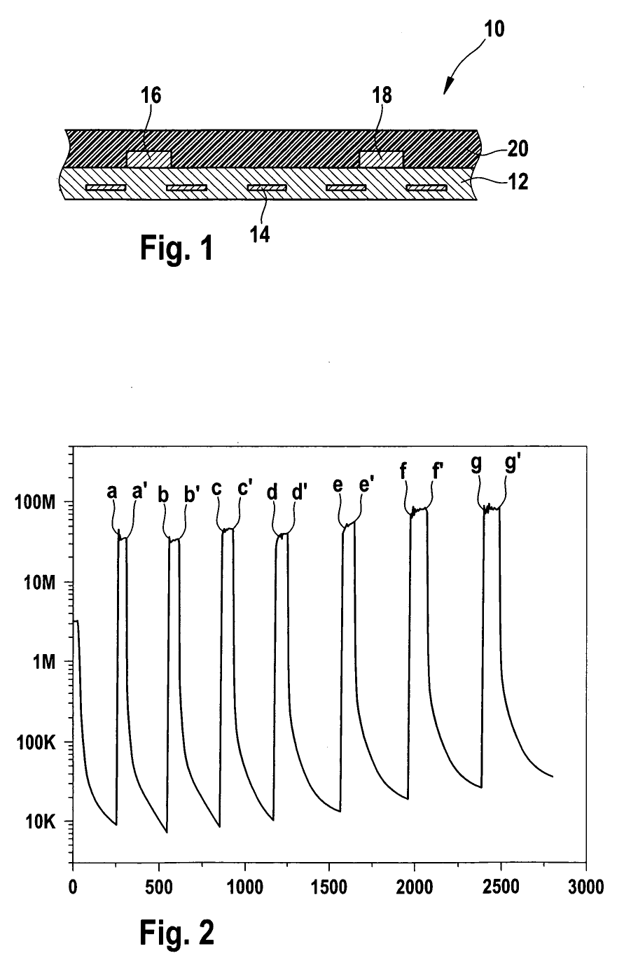

The method according to the present invention for determining acidic gases in gas mixtures uses in particular a sensor such as schematically illustrated in FIG. 1. Acidic gas is understood to be a gas producing an acidic reaction in an aqueous solution. These gases include hydrogen halides, sulfur oxides, hydrogen cyanide, nitrogen oxides, or vapors of acidic oxides.

Sensor 10 illustrated in FIG. 1 includes a substrate 12, which is preferably made of a semiconductor material such as silicon. Substrate 12 has a heating device 14, which is schematically shown in FIG. 1. At least two measuring electrodes 16, 18, which may be designed as interdigital electrodes, are mounted on the major surface of substrate 12. Measuring electrodes 16, 18 are preferably covered by a sensitive layer 20. Sensitive layer 20 is made of a polymeric material, whose electrical conductance, i.e., electrical resistance, changes upon contact with an acidic gas.

Polyaniline or a polyaniline copolymer which may be obtained by copolymerization of aniline and aniline derivatives such as aminobenzoic acids or aminobenzenesulfonic acids are particularly suitable as the polymer material of sensitive layer 20. 2-aminobenzoic acids, 3-aminobenzoic acids, 4-aminobenzoic acids, or 3-aminobenzenesulfonic acids are suitable in particular as aniline derivatives. Polymerization is preferably performed electrochemically. In doing so, aniline polymers are obtained potentiostatically at a voltage of +800 mV to +1000 mV against a standard calomel electrode (SCE); in addition to this method, aniline may also be obtained galvanostatically at a current density of approximately 20 A/m²−50 A/m² or potentiodynamically; in the potentiodynamic method voltage is varied in a range of approximately −20 mV to +1.0 V, and a rate of variation of approximately 10 mV/s to 30 mV/s is used. A 0.1 molar monomer solution, which also preferably contains 0.1 mol of sulfuric acid, is used as the electrolyte for electrochemical polymerization.

To determine the concentration of the acidic gas to be measured in the gas mixture, a constant electrical voltage is applied to measuring electrodes 16, 18, and the electrical resistance or the electrical conductance of sensitive layer 20 is determined. Alternatively, instead of a DC voltage, it is also possible to apply an AC voltage to measuring electrodes 16, 18 and to measure the impedance established between measuring electrodes 16, 18. A third possibility is to apply a constant current to measuring electrodes 16, 18 and to determine the voltage established across measuring electrodes 16, 18. The change in electrical conductance, the electrical resistance, or the impedance, possibly per unit of time, may be used as a measure of the concentration of the gas to be determined.

An alternative is to provide four measuring electrodes and to measure the electrical resistance of sensitive layer 20 by the four-point measurement method. In this case, four measuring electrodes are provided, a pair of external measuring electrodes surrounding or flanking a pair of internal measuring electrodes. The external measuring electrodes are spaced from the internal measuring electrodes and the internal measuring electrodes are spaced from one another by strips of the sensitive layer. To determine the electrical resistance of the sensitive layer, a voltage of 50 mV, for example, is applied to the external measuring electrodes and the current flowing between the external measuring electrodes is measured. Furthermore, the voltage drop across the internal measuring electrodes is measured at a high resistance. The electrical resistance of the sensitive layer is obtained by dividing the voltage drop across the internal measuring electrodes by the current flowing between the external measuring electrodes. This allows the electrical resistance of the sensitive layer to be determined, eliminating the effect of the contact resistance between the electrode material and the polymer material of the sensitive layer. Polarization effects may be prevented by applying an AC voltage having a frequency of 0.5 Hz-50 Hz instead of a DC voltage.

Given contact with an acidic gas, the polyaniline of sensitive layer 20 goes from a neutral, uncharged state corresponding to an emeraldine base into a protonized, charged, and thus electrically conductive state. This results in a decrease in the electrical resistance by a factor of approximately 10³. At room temperature, chemical absorption of the acidic gas to be determined is largely irreversible; however, it has been found that desorption of acidic gases is possible at higher temperatures. For this purpose, at defined points in time, sensor 10 is brought to a higher temperature using heating element 14, and preferably held at this higher temperature for a defined period. Sensor 10 is heated either when needed, for example, upon saturation of sensitive layer 20 with a gas to be determined, or periodically. Time intervals from 30 minutes up to 12 months, in particular between one day and 30 days, may be selected between the individual regeneration operations. Sensor 10 is preferably heated to a temperature between 60° C. to 400° C., in particular between 100° C. and 180° C. for regeneration. To regenerate sensitive layer 20 as needed, sensor 10 may also have a temperature measuring device (not shown), which is used for determining the temperature of the sensitive layer.

Minimum time period tₘᵢₙ in milliseconds for which the sensor element must be held at the higher temperature for full desorption of the acidic gas is obtained from the following formula (1)
tₘᵢₙ=exp(a/T) (1)
where a is a number between 3000 and 4000, in particular between 3500 and 3800, and T is the higher temperature in Kelvin.

A first regeneration is preferably to be performed before sensor 10 is used for the first time.

In an alternative embodiment, a plurality of sensors may be arranged in an array, in such a way that multiple acidic gases may be determined simultaneously. The individual sensors differ with respect to the design of their sensitive layers or with respect to a protective layer to be applied to the sensitive layer, which has selective absorption materials for certain gases, for example.

FIG. 2 shows a measuring curve obtained using sensor 10 illustrated in FIG. 1. It corresponds to the electrical resistance in ohms (k=kilo-ohm; M=mega-ohm) plotted against time in seconds on a logarithmic scale.

A sensitive layer of polyaniline was used, which was pretreated using a suitable buffer, for example, a 0.2-molar solution of a hydrogen carbonate/carbonate buffer. The pretreatment is preferably conducted for a period of 10 minutes to 12 hours. This pretreatment is used for replacing the sulfate contained in the polymer with carbonate, which is removed as carbon dioxide in a first heat treatment.

The sensitive layer is exposed to a gas atmosphere containing 80 ppm hydrogen chloride for several minutes before the layer is regenerated by heating to 150° C. for 1 to 2 minutes. The graph shows that regeneration results in a steep increase in the electrical resistance of sensitive layer 20 at points in time a, b, c, d, e, f, g, while a decrease in electrical resistance of sensitive layer 20 due to absorption of the gas to be determined is to be observed after completion of the regeneration at points in time a′, b′, c′, d′, e′, f′, g′.

The above-described method for determining acidic gases is suitable in particular for early detection of smoldering or cable fires and thus for use in fire detectors or for determining the concentration of acidic gases in garbage-burning systems.

What is claimed is:

1. A method for determining acidic gases in gas mixtures, comprising:
exposing a polymer layer which changes its electrical conductance under the effect of a gas to be determined to a gas mixture;
determining at least one of an electrical conductance, an electrical resistance, and an impedance of the polymer layer; and
heating the polymer layer to a temperature higher than an ambient temperature at defined time intervals for desorption of the gas to be determined.

2. The method according to claim 1, wherein the gas to be determined is one of hydrogen chloride, sulfur dioxide and nitrogen dioxide.

3. The method according to claim 1, wherein the polymer layer is a polymer having basic functional groups.

4. The method according to claim 1, wherein the polymer layer includes a polyaniline.

5. The method according to claim 4, wherein the polyaniline includes a copolymer of aniline with one of an aminobenzoic acid and an aminobenzenesulfonic acid.

6. The method according to claim 1, further comprising:
determining at least one of the electrical conductance, the electrical resistance, and the impedance of the polymer layer using at least two electrodes, which are in contact with the polymer layer; and
measuring at least one of a current flowing between the electrodes and a voltage applied between the electrodes.

7. The method according to claim 1, further comprising heating the polymer layer to an elevated temperature of 60° C. to 400° C.

8. The method according to claim 1, further comprising periodically heating the polymer layer.

9. The method according to claim 1, further comprising determining a period t in milliseconds within which the polymer layer is held at an elevated temperature according to the formula t=exp(a/T), where a is a number between 3000 and 4000, and T is the elevated temperature in Kelvin.

10. The method according to claim 1, wherein the method is used for early detection of fires.

11. A sensor for determining acidic gases in gas mixtures, comprising:
a polymer layer which changes its electrical conductance under the effect of a gas to be determined;
at least two electrodes which are in contact with the polymer layer; and
at least one heating element for heating the polymer layer to a temperature elevated with respect to an ambient temperature at defined time intervals for desorption of the gas to be determined.

12. The sensor according to claim 11, wherein the gas to be determined is one of hydrogen chloride, sulfur dioxide and nitrogen dioxide.

13. The sensor according to claim 11, further comprising a temperature measuring element for determining the temperature of the polymer layer.

14. The sensor according to claim 11, wherein the sensor is used for early detection of fires.
